(19) United States
(12) Patent Application Publication
(10) Pub. No.: US 2009/0234076 A1
(43) Pub. Date: Sep. 17, 2009

(54) PROPYLENE-BASED BLOCK COPOLYMER PARTICLES

(75) Inventor: Kenichiro Yada, Sodegaura-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED, Tokyo (JP)

(21) Appl. No.: 12/402,550

(22) Filed: Mar. 12, 2009

(30) Foreign Application Priority Data
Mar. 14, 2008 (JP) 2008-066256

(51) Int. Cl. C08L 23/16

(52) U.S. Cl. 525/240

(57) ABSTRACT

Propylene-based block copolymer particles in accordance with the present invention are obtained by copolymerizing ethylene and propylene to form an ethylene-propylene copolymer in the presence of propylene polymer particles. The ratio of the intrinsic viscosity η_{A} of a 20° C. xylene-soluble component of the copolymer particles to the intrinsic viscosity η_{B} of a 20° C. xylene-insoluble component of the copolymer particles, η_{A}/η_{B}, is 2.9 to 7.5. The content of the ethylene-propylene copolymer is 5 to 50 wt. % on the basis of the total weight of the block copolymer particles. The ethylene content of the ethylene-propylene copolymer is 20 to 55 wt. % on the basis of the weight of the ethylene-propylene copolymer. The standard deviation of the ethylene contents of the individual block copolymer particles is less than 7.

### BACKGROUND OF THE INVENTION

1. Field of the Invention

The present invention relates to a propylene-based block copolymers.

2. Related Background Art

Propylene-based block copolymer resins used for automobile components, home electronic products, and the like are required to be well-balanced in rigidity and impact resistance, and therefore propylene-based block copolymers having a propylene homopolymer and an ethylene-propylene copolymer are typically used for such applications. Many propylene-based block copolymers are produced by a method having a first polymerization process in which propylene is homopolymerized and a subsequent second polymerization process in which propylene and ethylene are copolymerized. Propylene-based block copolymers produced in such a manner is sometimes called “high impact propylene-based copolymers” and are customarily referred to in Japan as “propylene-based block copolymers”.

A property called “gel content” is one of the items important for evaluating the quality of propylene-based block copolymers. The term “gel” as referred to herein means foreign matter present in the surface or inside of a molded article or film of a propylene-based block copolymer. Because gel in the surface of a molded article can be visually observed is visually recognizable, molded articles with a large amount of gel have defective external appearance. Gel not only impairs the external appearance of molded articles, but also adversely affects mechanical properties such as rigidity and impact resistance of molded articles. Therefore, it is preferred that propylene-based copolymers contain gel as less as possible.

It is known that in a propylene-based block copolymer having a propylene homopolymer and an ethylene-propylene copolymer, a gel originating in the ethylene-propylene copolymer occurs easier as the content of the ethylene-propylene copolymer formed in the above-described second polymerization process increases. Meanwhile impact resistance of a molded article is known to decrease as the content of the ethylene-propylene copolymer decreases (see Japanese Patent Application Laid-Open No. 2002-356525).

### SUMMARY OF THE INVENTION

The gel content of a propylene-based block copolymer, however, does not depend only on the ethylene-propylene copolymer content in the propylene-based block copolymer, and it is necessary to adjust a variety of structural values in order to reduce the gel content. The reduction of gel content in conventional propylene-based block copolymers is still insufficient, and external appearance of molded articles manufactured using the propylene-based block copolymers and the balance between the rigidity and the impact resistance thereof are yet to be improved.

The present invention was created in view of the foregoing, and it is an object of the present invention to provide propylene-based block copolymer particles suitable for obtaining a molded article that has excellent external appearance and has highly balanced rigidity and impact resistance.

Propylene-based block copolymer particles in accordance with the present invention are obtained by copolymerizing ethylene and propylene to form an ethylene-propylene copolymer in the presence of propylene polymer particles, and are characterized in that the ratio of the intrinsic viscosity η_{A} of a 20° C. xylene-soluble component to the intrinsic viscosity η_{B} of a 20° C. xylene-insoluble component, η_{A}/η_{B}, is 2.9 to 7.5, that the content of an ethylene-propylene copolymer is 5 to 50 wt. % on the basis of the total weight of the propylene-based block copolymer particles, that the ethylene content of the ethylene-propylene copolymer is 20 to 55 wt. % on the basis of the weight of the ethylene-propylene copolymer, and that the standard deviation of the ethylene contents of the propylene-based block copolymer particles is less than 7.

The propylene-based block copolymer particles of the present invention are higher in uniformity of the ethylene content distribution among particles than conventional ones because the standard deviation of the ethylene contents of the particles of the present invention is less than 7. As a result, the propylene-based block copolymer particles of the present invention can give molded articles having good external appearance and having well-balanced rigidity and impact resistance because of containing a reduced amount of gel.

Further, the propylene-based block copolymer particles of the present invention can give molded articles having excellent external appearance because the ratio of the intrinsic viscosity η_{A} of a 20° C. xylene-soluble component of the block copolymer particles to the intrinsic viscosity η_{B} of a 20° C. xylene-insoluble component of the block copolymer particles, η_{A}/η_{B}, is 2.9 to 7.5. It is also preferred that the intrinsic viscosity η_{A} of the 20° C. xylene-soluble component be 3.0 to 7.0 dl/g. By using a propylene-based block copolymer particles with an intrinsic viscosity η_{A} within this range, it is possible to manufacture a large molded article with excellent external appearance by injection molding.

Furthermore, in the propylene-based block copolymer particles in accordance with the present invention, the ethylene content of the ethylene-propylene copolymer contained therein is 20 to 55 wt. % on the basis of the weight of the ethylene-propylene copolymer. By using a block copolymer particles in which the ethylene content of the ethylene-propylene copolymer is within the above-described range, it is possible to optimize the elongation and low-temperature impact properties of molded articles.

From the standpoint of the rigidity, the heat resistance, and the hardness of a molded article, it is preferred that the propylene homopolymer contained in the propylene-based block copolymer particles have an isotactic pentad fraction of 0.98 or more.

The present invention provides propylene-based block copolymer particles suitable for obtaining a molded article that has excellent external appearance and excels in balance between rigidity and impact resistance.

### BRIEF EXPLANATION OF THE DRAWINGS

FIG. 1 is a schematic cross-sectional view illustrating the internal structure of a propylene-based block copolymer particle; and

FIG. 2 is a schematic structural diagram illustrating a propylene based block copolymer production system.

### DESCRIPTION OF THE PREFERRED EMBODIMENTS

The preferred embodiments of the present invention will be described below in detail with reference to the appended drawings.

<Propylene-Based Block Copolymer Particles>

The propylene-based block copolymer particles in accordance with the present invention are obtained via a first polymerization process in which propylene homopolymer particles are provided by homopolymerizing propylene and a second polymerization process in which an ethylene-propylene copolymer is produced by copolymerizing ethylene and propylene to form an ethylene-propylene copolymer in the presence of the propylene homopolymer particles.

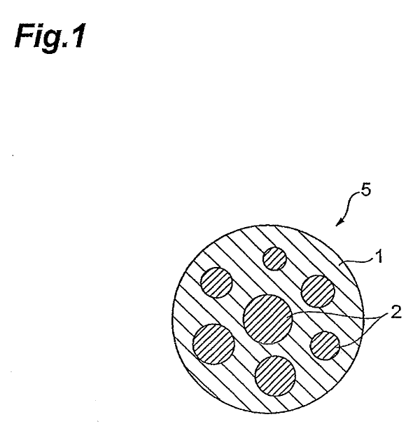

As illustrated in FIG. 1, particles 5 of a propylene-based block copolymer contain a part 1 (referred to hereinbelow as “PP part 1”) composed of a propylene homopolymer and a part 2 (referred to hereinbelow as “EP part 2”) composed of an ethylene-propylene copolymer.

In the propylene-based block copolymer particles obtained via the first polymerization process and the second polymerization process (referred to hereinbelow as “block copolymer particles”), the content of the EP part 2 is 5 to 50 wt. % on the basis of the total weight of the block copolymer particles. Where the content of the EP part 2 is less than 5 wt. %, the impact resistance of molded articles is insufficient, and when this content is more than 50 wt. %, the rigidity of molded articles is insufficient. The content of the EP part 2 is preferably 7 to 48 wt. %, more preferably 8 to 45 wt. %.

The content of the EP part 2 in the block copolymer particles, as referred to herein, means a value found by analysis using ¹³C-NMR. More specifically, it is a value measured under the following conditions by using an AVANCE 600 manufactured by Brucker Co. as a measurement device. Peak assignment is performed according to M. Kakugo et al. “Macromolecules”, Vol. 15, 1150 (1982).

Measurement mode: proton decoupling.

Pulse width: 8 μsec.

Pulse repetition: 4 sec.

Number of scans: 20,000.

Solvent: mixed solvent of 1,2-dichlorobenzene (75 vol. %) and 1,2-dichlorobenzene-d4 (25 vol. %).

Internal chemical shift reference: tetramethylsilane.

Sample concentration: 200 mg/3.0 ml-solvent.

The standard deviation of the ethylene contents of the individual block copolymer particles 5 is less than 7. If the standard deviation of the ethylene contents is equal to or greater than 7, it is difficult to reduce the amount of gel produced in molded articles. The standard deviation of the ethylene contents is preferably less than 6 and even more preferably less than 5.

The standard deviation of the ethylene contents of the individual block copolymer particles as referred to herein means a value measured in the following manner. Specifically, a particle is sampled from the block copolymer particles, and a tabular sample is prepared by heating the particle to 190° C. and molding it. The ethylene content of the sample is measured using an FT/IR-470Plus (trade name) manufactured by JASCO Corporation. The assignment of FT/IR ethylene absorption is performed according to the method relating to (i) Random Copolymer described in “Polymer Analysis Handbook, New Edition”, Kinokuniya Shoten (1995), page 616. Seventy tabular samples are prepared and the ethylene content of each sample is measured as described above. A standard deviation of the 70 measurements is taken as the standard deviation of the ethylene contents of the individual block copolymer particles.

The ratio (η_{A}/η_{B}) of the intrinsic viscosity η_{A} of a 20° C. xylene-soluble component of the block copolymer particles and the intrinsic viscosity η_{B} of a 20° C. xylene-insoluble component of the block copolymer particles preferably is 2.9 to 7.5.

If the ratio (η_{A}/η_{B}) of the intrinsic viscosities is less than 2.9, a molded article with desired good external appearance cannot be obtained and adhesion between the block copolymer particles decreases. If the ratio (η_{A}/η_{B}) of the intrinsic viscosities is greater than 7.5, ethylene-propylene copolymer parts cannot be dispersed uniformly in molded articles, and as a result, the molded articles will come to have poor external appearance and greatly reduced surface impact strength. The ratio (η_{A}/η_{B}) of the intrinsic viscosities is preferably 3.0 to 7.3, more preferably 3.1 to 7.1.

It is preferred that the intrinsic viscosity η_{A} of a 20° C. xylene-soluble component of the particle 5 be as high as possible. More specifically, this intrinsic viscosity is preferably equal to or greater than 3.0 dl/g, more preferably equal to or greater than 3.2 dl/g, and even more preferably equal to or greater than 3.5 dl/g. When the intrinsic viscosity η_{A} is equal to or greater than 3.0 dl/g, a large molded article with excellent external appearance can be manufactured by injection molding. If the intrinsic viscosity η_{A} is excessively high, gel tends to generate in an amount so high that it cannot be compensated by improving the polymerization method. Therefore, the upper limit is preferably 15 dl/g, more preferably 10 dl/g.

The intrinsic viscosity η_{B} of a 20° C. xylene-insoluble component of the particle 5 is preferably 0.8 to 2.0 dl/g, more preferably 0.9 to 1.8 dl/g. If the intrinsic viscosity η_{B} is less than 0.8 dl/g, the toughness of molded articles tends to decrease significantly. If the intrinsic viscosity is more than 2.0 dl/g, the flowability of a block copolymer tends to worsen.

The intrinsic viscosity η_{A} and the intrinsic viscosity η_{B} referred to herein mean values measured by the following method. Specifically, 2 g of block copolymer particles are completely dissolved in 2 L of boiling xylene. The temperature is then reduced to 20° C. and the solution is left at rest for 15 hr at about 20° C. The resultant system is separated by filtration into a solution and a precipitate, and the filtrate is dried to solidify. The solid obtained from the filtrate, which is a 20° C. xylene-soluble component, and the precipitate, which is a 20° C. xylene-insoluble component, are individually dried at 70° C. under reduced pressure. The intrinsic viscosities (η_{A}, η_{B}) of the two obtained samples are measured using an Ubbelohde viscometer. The measurement temperature is 135° C., and tetralin is used as the solvent.

The ethylene content of the EP part 2 in the block copolymer particles is 20 to 55 wt. % on the basis of the total weight of the EP part 2. If this value is less than 20 wt. %, the impact resistance of molded articles is insufficient, and if this value is more than 55 wt. %, molded articles will be poor in external appearance, impact resistance at normal temperature, and surface impact resistance. The content of ethylene in the EP part 2 is preferably 23 to 53 wt. %, more preferably 25 to 50 wt. %.

The content of ethylene in the EP part 2 as referred to herein means a value found by analysis using ¹³C-NMR. More specifically, it is a value measured in the same manner as that in the measurement of the content of the EP part 2 in the block copolymer particles.

From the standpoint of the rigidity and the heat resistance of molded articles, it is preferred that the isotactic pentad fraction (mmmm) of the PP part 1 in the block copolymer particles be equal to or greater than 0.98.

The isotactic pentad fraction of the PP part 1 of the particle 5 as referred to herein means a value found by analysis using ¹³C-NMR. More specifically, it is a value measured under the following conditions by using an AVANCE 600 manufactured by Brucker Co. as a measurement device. Peak assignment is performed according to A. Zambelli et al. “Macromolecules”, Vol. 6, No. 6, 925 (1973).

Measurement mode: proton decoupling.

Pulse width: 8 μsec.

Pulse repetition: 4 sec.

Number of scans: 20,000.

Solvent: mixed solvent of 1,2-dichlorobenzene (75 vol. %) and 1,2-dichlorobenzene-d4 (25 vol. %).

Internal chemical shift reference: tetramethylsilane.

Sample concentration: 200 mg/3.0 ml-solvent.

<Method for Producing Propylene-Based Block Copolymer>

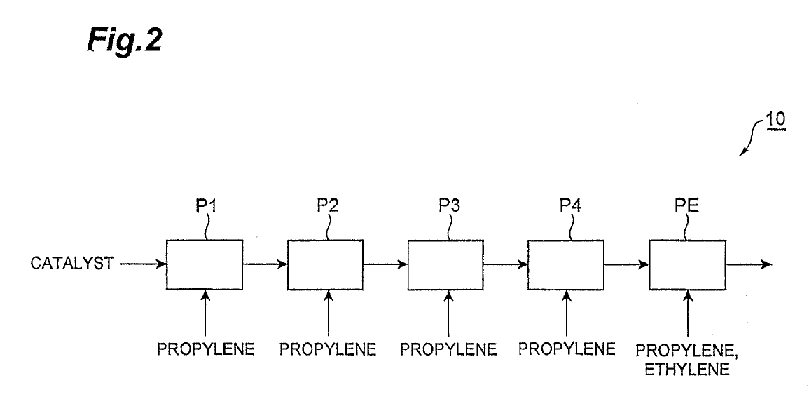

A propylene-based block copolymer production system 10 shown in FIG. 2 is a system for producing propylene-based block copolymer particles by continuous polymerization. The production system 10 is provided with four polymerization reactors P1, P2, P3, and P4 disposed on the upstream side and one copolymerization reactors PE disposed on the downstream side. The polymerization reactors P1, P2, P3, and P4 and the copolymerization reactors PE are linked in series and a product is transferred successively from an upstream reactor to a downstream reactor. Further, the polymerization reactors P1, P2, P3, and P4 are each provided with a line for supplying propylene thereto and the copolymerization reactor PE is provided with a line for supplying propylene and ethylene thereto.

In the propylene-based block copolymer production system 10, a solid catalyst and propylene are continuously supplied to the polymerization reactor P1, so that polypropylene particles each enclosing the solid catalyst are produced there. The polypropylene particles are extracted continuously from the reactor P1. Then, propylene and the polypropylene particles extracted from the propylene polymerization reactor P1 are continuously supplied to the propylene polymerization reactor P2, so that the polypropylene particles are grown there. The grown particles are then extracted from the reactor P2 continuously. Then, propylene and the polypropylene particles extracted from the reactor P2 are continuously supplied to the polymerization reactor P3, so that the polypropylene particles are grown there. The grown particles are then extracted from the reactor P3. Then, propylene and the polypropylene particles extracted from the reactor P3 are continuously supplied to the polymerization reactor P4, so that the polypropylene particles are grown there. A homopolymerization process constituted by the polymerizations in the reactors P1, P2, P3 and P4 is referred to as a first polymerization stage. The propylene particles grown in the reactor P4 is extracted from the reactor P4 and transferred toward the subsequent copolymerization reactor PE.

It is necessary to externally supply propylene serving as a starting material continuously to the polymerization reactor P1. As to the polymerization reactors P2, P3 and P4, however, when untreated propylene is continuously supplied together with polypropylene particles from their upstream polymerization reactor, it is not always necessary to externally supply propylene.

Propylene, ethylene, and the polypropylene particles transferred from the polymerization reactor P4 are continuously supplied to the copolymerization reactor PE, so that a copolymer of propylene and ethylene is produced inside polypropylene particles. This copolymerization process is referred to as a second polymerization stage.

The block copolymer particles of the present invention can be produced by setting an average residence time of each polymerization reactor of the first polymerization stage at a specified length. The average residence time of particles in a polymerization reactors as referred to herein means a value obtained by dividing the weight (unit: kg) of the particles accommodated in the reactor by the weight flow rate (unit: kg/hr) of the particles extracted from the reactor. When the reactor is a liquid-phase polymerization reactor, the average residence time means a value obtained by dividing the amount (unit: m³) of the liquid accommodated in the reactor by the volume flow rate (unit: m³/hr) of the particle-containing liquid extracted from the reactor.

In the first polymerization stage performed in the four polymerization reactors P1, P2, P3, and P4, it is preferable that the average residence time of polypropylene particles in each propylene polymerization reactor be 0.1 to 2 hr, and simultaneously that the sum total of the average residence times of the polymerization reactors P1, P2, P3, and P4 be 2 to 3.5 hr. By setting the average residence times of the propylene polymerization reactors P1, P2, P3, and P4 and the sum total of the average residence times within the aforementioned ranges, it is possible to sufficiently decrease the residence time distribution of polypropylene particles in the propylene polymerization reactors P1, P2, P3, and P4. As a result, the polypropylene particles which are to be discharged from the propylene polymerization reactor P4 and to be introduced into the copolymerization reactor PE can be rendered sufficiently uniform in particle size.

If the average residence time of polypropylene particles in each propylene polymerization reactor is less than 0.1 hr, the polymerization of propylene tends to advance insufficiently. On the other hand, if the average residence times are longer than 2 hr, the residence time distribution of polypropylene particles broadens, so that the obtained polypropylene particles tend to become uneven in particle diameter. Further, if the sum total of the average residence times of polypropylene particles in the polymerization reactors P1, P2, P3, and P4 is less than 2 hr, the polymerization of propylene tends to advance insufficiently. On the other hand, if the sum total is longer than 3.5 hr, the polymerization of propylene advances excessively, so that the particle 5 tends to come to contain an excessive amount of PP part 1.

From the standpoint of further reducing the amount of gel to be formed in molded articles and improving the operation efficiency, it is preferred that the average residence time of polypropylene particles in each propylene polymerization reactor be 0.15 to 1.7 hr, more preferably 0.2 to 1.6 hr. Further, from the same standpoints as the foregoing, it is preferred that the sum total of the average residence times of polypropylene particles in the propylene polymerization reactors P1, P2, P3, and P4 be 1.7 to 3.3 hr, more preferably 1.9 to 3.0 hr.

The average residence time of the particles in the copolymerization reactor PE may be determined appropriately according to the application of the manufactured propylene-based block copolymer particles.

The reason why the average residence time in the copolymerization reactor PE may be determined appropriately while the average residence times in the polymerization reactors P1, P2, P3, and P4 must be determined in the manner described above in the present embodiment is related to the activity of the solid catalyst described below.

In the first polymerization stage of the present embodiment, a propylene homopolymer component grows around a solid catalyst as a result of polymerization of propylene, so that polypropylene particles are formed. On the other hand, in the second polymerization stage, a propylene-ethylene copolymer component is grown, so that a propylene-based block copolymer is formed. Thus, the solid catalyst participates in both the propylene homopolymerization reaction and the subsequent copolymerization reaction.

At the stage of propylene homopolymerization (first polymerization stage), the activity of the solid catalyst is higher, in other words, the propylene polymerization reaction rate is greater, than that of the stage of copolymerization of propylene and ethylene (second polymerization stage). Accordingly, a certain difference in residence time tends to cause a significant difference in activity among polypropylene particles. Therefore, the average residence time should be specified as described above. Meanwhile, at the stage of copolymerization of propylene and ethylene (second polymerization stage), the activity of the solid catalyst has been lowered, so that the copolymerization reaction advances comparatively slowly. Therefore, a propylene-based block copolymer having a highly uniform distribution of ethylene content among copolymer particles can be obtained even if the average residence time is not set strictly.

In the present embodiment, it is preferred that a propylene-based block copolymer be produced in a specified amount to the weight of the solid catalyst used. Specifically, when the weight of the solid catalyst supplied to the propylene homopolymerization and the copolymerization of propylene and ethylene is let be 1 part by weight, it is preferred that the propylene homopolymerization and the copolymerization of propylene and ethylene be carried out so that the weight of the propylene-based block copolymer will become 15,000 to 70,000 parts by weight (more preferably 20,000 to 40,000 parts by weight).

If the amount of the propylene-based block copolymer produced for 1 part by weight of the solid catalyst is less than 15,000 parts by weight, a large amount of solid catalyst residue remains in the produced propylene-based block copolymer, so that the color tone or long-term stability of the product tend to degrade. On the other hand, if the amount of the propylene-based block copolymer produced exceeds 70,000 parts by weight, operational deficiencies tend to occur; for example, it may become difficult to control the temperature inside the polymerization reactors or, in a gas-phase polymerization reactor, the copolymer particles come to have poor flowability due to increase in weight of the copolymer particles.

As described above, the propylene-based block copolymer produced in the present embodiment has high uniformity of ethylene content distribution among the particles thereof. Therefore, the number of gel in molded articles produced by using this block copolymer can be reduced sufficiently.

Specific examples of the solid catalyst, the polymerization reactors P1, P2, P3, and P4, and the copolymerization reactor PE used in the present embodiment will be described below.

Solid Catalyst

Solid catalysts known in the art that are suitable for olefin polymerization can be used in the present embodiment. Examples of such catalysts include solid catalysts obtained by bringing a solid catalyst component containing titanium, magnesium, a halogen and an electron donor, an organoaluminum compound component, and an electron donor component into contact with each other. The catalyst component is referred to hereinbelow as a catalyst component (A).

A catalyst which is generally called a titanium-magnesium composite catalyst can be used as the catalyst component (A), and this component can be obtained by bringing a titanium compound, a magnesium compound, and an electron donor, each described below, into contact with each other.

Examples of titanium compounds that can be used for the preparation of the catalyst component (A) include titanium compounds represented by a formula Ti(OR¹)ₐX₄₋ₐ (R¹ is a monovalent hydrocarbon group having 1 to 20 carbon atoms, X is a halogen atom, and a is a number satisfying 0≦a≦40). Specific examples include tetrahalogenated titanium compounds such as titanium tetrachloride; trihalogenated alkoxytitanium compounds such as ethoxytitanium trichloride and butoxytitanium trichloride; dihalogenated dialkoxytitanium compounds such as diethoxytitanium dichloride and dibutoxytitanium dichloride; monohalogenated trialkoxytitanium compounds such as triethoxytitanium chloride and tributoxytitanium chloride; and tetraalkoxytitanium compounds such as tetraethoxytitanium and tetrabutoxytitanium. Such titanium compounds may be used solely or in combinations.

Examples of magnesium compounds that can be used for the preparation of the catalyst component (A) include magnesium compounds having a magnesium-carbon bond or a magnesium-hydrogen bond and being capable of demonstrating a reduction activity, or magnesium compounds that have no reduction activity. Specific examples of magnesium compounds which can demonstrate a reduction activity include dialkylmagnesium compounds such as dimethylmagnesium, diethylmagnesium, dibutylmagnesium, and butylethylmagnesium; alkylmagnesium halide compounds such as butylmagnesium chloride; alkylalkoxymagnesium compounds such as butylethoxymagnesium; and alkylmagnesium hydrides such as butylmagnesium hydride. Such magnesium compounds which can demonstrate a reducing activity may be used in the form of complexes with organoaluminum compounds. Specific examples of magnesium compounds which can demonstrate no reducing activity include dihalogenated magnesium compounds such as magnesium dichloride; alkoxymagnesium halide compounds such as methoxymagnesium chloride, ethoxymagnesium chloride, and butoxymagnesium chloride; dialkoxymagnesium compounds such as diethoxymagnesium and dibutoxymagnesium; and magnesium carboxylates such as magnesium laurate and magnesium stearate. Such magnesium compounds which can demonstrate no reducing activity may be synthesized, in advance or when the catalyst component (A) is prepared, by a known method from magnesium compounds which can demonstrate a reducing activity.

Examples of electron donors that can be used for the preparation of the catalyst component (A) include oxygen-containing electron donors such as alcohols, phenols, ketones, aldehydes, carboxylic acids, esters of organic acids or inorganic acids, ethers, acid amides, and acid anhydrides; nitrogen-containing electron donors such as ammonia compounds, amines, nitrites, and isocyanates; and organic acid halides. Among these electron donors, inorganic acid esters, organic acid esters, and ethers are preferred.

Preferred examples of inorganic acid esters include silicon compounds represented by a formula R²ₙSi(OR³)₄₋ₙ, wherein R² represents a monovalent hydrocarbon group having 1 to 20 carbon atoms or a hydrogen atom; R³ represents a monovalent hydrocarbon group having 1 to 20 carbon atoms; n is a number satisfying 0≦n≦4. Specific examples include tetraalkoxysilanes such as tetramethoxysilane, tetraethoxysilane, and tetrabutoxysilane; alkyltrialkoxysilanes such as methyltrimethoxysilane, ethyltrimethoxysilane, butyltrimethoxysilane, isobutyltrimethoxysilane, tert-butyltrimethoxysilane, methyltriethoxysilane, ethyltriethoxysilane, butyltriethoxysilane, isobutyltriethoxysilane, and tert-butyltriethoxysilane; and dialkyldialkoxysilanes such as dimethyldimethoxysilane, diethyldimethoxysilane, dibutyldimethoxysilane, diisobutyldimethoxysilane, di-tert-butyldimethoxysilane, butylmethyldimethoxysilane, butylethyldimethoxysilane, tert-butylmethyldimethoxysilane, dimethyldiethoxysilane, diethyldiethoxysilane, dibutyldiethoxysilane, diisobutyldiethoxysilane, di-tert-butyldiethoxysilane, butylmethyldiethoxysilane, butylethyldiethoxysilane, and tert-butylmethyldiethoxysilane.

Preferred examples of organic acid esters include mono- or polycarboxylic acid esters, such as aliphatic carboxylic acid esters, alicyclic carboxylic acid esters, and aromatic carboxylic acid esters. Specific examples include methyl acetate, ethyl acetate, methyl propionate, ethyl propionate, ethyl butyrate, ethyl valerate, methyl acrylate, ethyl acrylate, methyl methacrylate, ethyl benzoate, butyl benzoate, methyl toluate, ethyl toluate, ethyl anisate, diethyl succinate, dibutyl succinate, diethyl malonate, dibutyl malonate, dimethyl maleate, dibutyl maleate, diethyl itaconate, dibutyl itaconate, diethyl phthalate, di-n-butyl phthalate, and diisobutyl phthalate. Preferred among them are unsaturated aliphatic carboxylic acid esters such as methacrylic acid esters and phthalic acid esters such as maleic acid esters, and even more preferred are phthalic acid diesters.

Examples of ethers include dialkyl ethers such as diethyl ether, dibutyl ether, diisobutyl ether, diamyl ether, diisoamyl ether, methyl butyl ether, methyl isoamyl ether, and ethyl isobutyl ether. Preferred among them are dibutyl ether and diisoamyl ether.

Examples of organic acid halides include mono- and polycarboxylic acid halides such as aliphatic carboxylic acid halides, alicyclic carboxylic acid halides, and aromatic carboxylic acid halides. Specific examples include acetyl chloride, propionic acid chloride, butyric acid chloride, valeric acid chloride, acrylic acid chloride, methacrylic acid chloride, benzoyl chloride, toluic acid chloride, anisic acid chloride, succinic acid chloride, malonic acid chloride, maleic acid chloride, itaconic acid chloride, and phthalic acid chloride. Preferred among them are aromatic carboxylic acid chlorides such as benzoyl chloride, toluic acid chloride, and phthalic acid chloride. Particularly preferred is phthalic acid chloride.

The following methods can be used for preparing the catalyst component (A).

(1) A method by which a liquid magnesium compound or a complex compound of a magnesium compound and an electron donor is caused to react with a precipitating agent and then treated with a titanium compound or with a titanium compound and an electron donor.

(2) A method by which a solid magnesium compound or a complex compound of a solid magnesium compound and an electron donor is treated with a titanium compound or a titanium compound and an electron donor.

(3) A method by which a liquid magnesium compound and a liquid titanium compound are caused to react in the presence of an electron donor, so that the obtained solid titanium composite is precipitated.

(4) A method by which the reaction product obtained by method (1), (2), or (3) is further treated with a titanium compound or an electron donor and a titanium compound.

(5) A method by which an alkoxytitanium compound is reduced by an organic magnesium compound such as a Grignard reagent in the presence of a silicon compound having an Si—O bond, and the obtained solid product is treated with an ester compound, an ether compound, and titanium tetrachloride.

(6) A method by which a solid product obtained by reducing a titanium compound with an organomagnesium compound in the presence of a silicon compound or a silicon compound and an ester compound is treated by successively adding a mixture of an ether compound and titanium tetrachloride and then an organic acid halide compound, and then the treated solid product is treated with a mixture of an ether compound and titanium tetrachloride or a mixture of an ether compound, titanium tetrachloride and an ester compound.

(7) A method by which a reaction product of a metal oxide, dihydrocarbylmagnesium and a halogen-containing alcohol is brought into contact with an electron donor and a titanium compound after or before treatment with a halogenating agent.

(8) A method by which a magnesium salt of an organic acid and a magnesium compound such as an alkoxymagnesium are brought into contact with an electron donor and a titanium compound after or before treatment with a halogenating agent.

(9) A method by which the compound obtained by any of the method (1) to (8) is treated with a halogen, a halogen compound, or an aromatic hydrocarbon.

Among these methods for preparing the catalyst component (A), methods (1) to (6) are preferred. These preparation methods are usually performed under an inert gas atmosphere such as nitrogen and argon.

In the preparation of the catalyst component (A), the titanium compound, silicon compound, and ester compound are preferably used after being dissolved or diluted with an appropriate solvent. Examples of suitable solvents include aliphatic hydrocarbons such as hexane, heptane, octane, and decane; aromatic hydrocarbons such as toluene and xylene; alicyclic hydrocarbons such as cyclohexane, methyl cyclohexane, and decalin; and ether compounds such as diethyl ether, dibutyl ether, diisoamyl ether, and tetrahydrofuran.

In the preparation of the catalyst component (A), the temperature of the reduction using an organomagnesium compound is usually −50° C. to 70° C. From the standpoint of increasing the catalytic activity and saving the cost, the temperature preferably is −30° C. to 50° C. and more preferably is −25° C. to 35° C. While the time period during which the organomagnesium compound is added dropwise is not particularly limited, it is usually about 30 min to about 12 hr. Upon completion of the reduction, a post-reaction may be further performed at a temperature of 20° C. to 120° C.

In the preparation of the catalyst component (A), a porous substance such as inorganic oxides and organic polymers may be used during the reduction, so that the porous substance is impregnated with a solid reduction product. The porous substance preferably has a pore volume of equal to or higher than 0.3 mL/g at a pore radius of 20 to 200 nm and has an average particle diameter of 5 to 300 μm. Examples of suitable porous inorganic oxides include SiO₂, Al₂O₃, MgO, TiO₂, ZrO₂, and complex oxides thereof. Examples of porous polymers include polystyrene-based porous polymers such as polystyrene and styrene-divinyl benzene copolymer; poly(acrylic ester)-based porous polymers such as poly(ethyl acrylate), methyl acrylate-divinyl benzene copolymer, poly(methyl methacrylate), and methyl methacrylate-divinyl benzene copolymer; and polyolefin-based porous polymers such as polyethylene, ethylene-methyl acrylate copolymer, and polypropylene. Among such porous substances, preferred are SiO₂, Al₂O₃, and styrene-divinyl benzene copolymer.

The catalyst component (A) may be converted into the form of a prepolymerized catalyst containing a solid catalyst obtained by polymerizing a small amount of an olefin prior to supplying to the polymerization. The prepolymerized catalyst may be referred to hereinbelow as “prepolymerized catalyst component”, and the polymerization of a small amount of olefin may be hereinbelow as “prepolymerization.” The amount of the olefin subjected to the prepolymerization is usually 0.1 to 200 g per gram of the catalyst component (A). A known method can be used for the prepolymerization. For example, the prepolymerization can be implemented in a slurry state by supplying a small amount of propylene and using a solvent in the presence of the catalyst component (A) and an organoaluminum compound. Examples of solvents suitable for the prepolymerization include inert saturated hydrocarbons such as propane, butane, isobutane, pentane, isopentane, hexane, heptane, octane and cyclohexane, inert aromatic hydrocarbons such as benzene and toluene, and liquid propylene. Mixtures of two or more such solvents may be used. The concentration of the slurry in the prepolymerization is usually 1 to 500 g, preferably 3 to 150 g, in terms of the weight of the catalyst component (A) contained in 1 L of the solvent.

The amount of the organoaluminum compound used in the prepolymerization is 0.1 to 700 mol, preferably 0.2 to 200 mol, more preferably 0.2 to 100 mol per mole of titanium atoms contained in the catalyst component (A). The prepolymerization may be performed in the presence of an electron donor, if necessary. The amount of the electron donor used in the prepolymerization is preferably 0.01 to 400 mol, more preferably 0.02 to 200 mol, even more preferably 0.03 to 100 mol per mole of titanium atoms contained in the catalyst component (A). A chain transfer agent such as hydrogen may also be used in the prepolymerization.

The prepolymerization temperature is usually −20° C. to 100° C., preferably 0 to 80° C. The prepolymerization time is usually 2 min to 15 h.

The organoaluminum compound component used in the preparation of the solid catalyst has at least one Al-carbon bond in a molecule, and typical compounds can be represented by the following formulae:

R⁴ₘAlY₃₋ₘ

R⁵R⁶Al—O—AlR⁷R⁸

wherein R⁴ is independently in each occurrence a monovalent hydrocarbon group having 1 to 8 carbon atoms; Y is independently in each occurrence a halogen atom, hydrogen, or an alkoxy group; and R⁵, R⁶, R⁷ and R⁸ are each independently a monovalent hydrocarbon group having 1 to 8 carbon atoms. Further, m is a number satisfying 2≦m≦3.

Specific examples of the organoaluminum compound component include trialkylaluminum such as triethylaluminum and triisobutylaluminum; dialkylaluminum hydride such as diethylaluminum hydride and diisobutylaluminum hydride; dialkylaluminum halides such as diethylaluminum chloride and diisobutylaluminum chloride; mixtures of trialkylaluminum and dialkylaluminum halide such as a mixture of triethylaluminum and diethylaluminum chloride; and alkylalumoxanes such as tetraethyldialumoxane and tetrabutyldialumoxane. Among such organoaluminum compounds, trialkylaluminum, a mixture of trialkylaluminum and dialkylaluminum halide, and alkylalumoxanes are preferred, and triethylaluminum, triisobutylaluminum, a mixture of triethylaluminum and diethylaluminum chloride, and tetraethyldialumoxane are more preferred.

Examples of electron donors that can be used for the preparation of the solid catalyst include oxygen-containing electron donors such as alcohols, phenols, ketones, aldehydes, carboxylic acids, esters of organic acids or inorganic acids, ethers, acid amides, and acid anhydrides; nitrogen-containing electron donors such as ammonia compounds, amines, nitrites, and isocyanates; and organic acid halides. Among such electron donors, inorganic acid esters, organic acid esters, and ethers are preferred.

Preferred examples of inorganic acid esters include silicon compounds represented by a formula R⁹ₙSi(OR¹⁰)₄₋ₙ wherein R⁹ represents independently in each occurrence a monovalent hydrocarbon group having 1 to 20 carbon atoms or a hydrogen atom; R¹⁰ is independently in each occurrence a monovalent hydrocarbon group having 1 to 20 carbon atoms; n is a number satisfying 0≦n≦4. Specific examples include tetrabutoxysilane, butyltrimethoxysilane, tert-butyl-n-propyldimethoxysilane, dicyclopentyldimethoxysilane, and cyclohexylethyldimethoxysilane.

Preferred ethers are dialkyl ethers and diether compounds represented by the general formula:

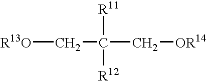

wherein R¹¹ to R¹⁴ are each independently a linear or branched alkyl group having 1 to 20 carbon atoms, an alicyclic hydrocarbon group, an aryl group, or an aralkyl group; R¹¹ or R¹² may be a hydrogen atom. Specific examples include dibutyl ether, diamyl ether, 2,2-diisobutyl-1,3-dimethoxypropane, and 2,2-dicyclopentyl-1,3-dimethoxypropane.

Among such electron donor components, organosilicon compounds represented by a formula R¹⁵R¹⁶Si(OR¹⁷) are particularly preferred. In the formula, R¹⁵ represents a monovalent hydrocarbon group having 3 to 20 carbon atoms that has a secondary or tertiary carbon atom adjacent to the Si atom, more specifically, a branched alkyl group such as an isopropyl group, a sec-butyl group, a tert-butyl group, and a tert-amyl group; a cycloalkyl group such as a cyclopentyl group and a cyclohexyl group; a cycloalkenyl group such as a cyclopentenyl group; and an aryl group such as a phenyl group and a tolyl group. R¹⁶ is a monovalent hydrocarbon group having 1 to 20 carbon atoms, more specifically, a linear alkyl group such as a methyl group, an ethyl group, a propyl group, a butyl group, and a pentyl group; a branched alkyl group such as an isopropyl group, a sec-butyl group, a tert-butyl group, and a tert amyl group; a cycloalkyl group such as a cyclopentyl group and a cyclohexyl group; a cycloalkenyl group such as a cyclopentenyl group; and an aryl group such as a phenyl group and a tolyl group. R¹⁷ is a monovalent hydrocarbon group having 1 to 20 carbon atoms, preferably a hydrocarbon group having 1 to 5 carbon atoms. Specific examples of organosilicon compounds that can be used as such an electron donor component include tert-butyl-n-propyldimethoxysilane, dicyclopentyldimethoxysilane, and cyclohexylethyldimethoxysilane.

The amount of the organoaluminum compound component that is used in the preparation of the solid catalyst is usually 1 to 1000 mol, preferably 5 to 800 mol per mole of titanium atoms contained in the catalyst component (A). The amount of the electron donor component is usually 0.1 to 2000 mol, preferably 0.3 to 1000 mol, more preferably 0.5 to 800 mol per mole of titanium atoms contained in the catalyst component (A).

Polymerization Reactors

In the polymerization reactors P1, P2, P3 and P4, propylene is homopolymerized in the presence of a solid catalyst, so that polypropylene particles are formed. Examples of suitable polymerization reactors P1, P2, P3 and P4 include liquid-phase polymerization reactor such as a slurry polymerization reactor and a bulk polymerization reactor or a gas-phase polymerization reactor such as an agitated gas-phase polymerization reactor and a fluidized bed gas-phase polymerization reactor.

Known polymerization reactors such as agitated reactors and loop reactors like those described in Japanese Examined Patent Application Publication Nos. 41-12916, 46-11670, and 47-42379 can be used as the slurry polymerization reactor. Known polymerization reactors such as agitated reactors and loop reactors like those described in Japanese Examined Patent Application Publication Nos. 41-12916, 46-11670, and 47-42379 can be used as the bulk polymerization reactor.

Known polymerization reactors, for example, the reactors described in Japanese Examined Patent Application Publication No. 46-31969 and Japanese Examined Patent Application Publication No. 59-21321 can be used as the agitated gas-phase polymerization reactor. Known polymerization reactors, for example, the reactors described in Japanese Unexamined Patent Application Publication Nos. 58-201802, 59-126406, and 2-233708 can be used as the fluidized gas-phase polymerization reactor.

The four polymerization reactors P1, P2, P3 and P4 may be identical or different in specifications. However, from the standpoint of preventing the occurrence of hot spots inside the reactors and improving the uniformity of reaction temperature, it is preferred that liquid-phase polymerization reactors be employed at least as the propylene polymerization reactors P1, P2. When an upstream-located liquid-phase polymerization reactor is used in combination with a downstream-located gas-phase polymerization reactor, a flushing tank may be provided between the two reactors in order to separate unreacted propylene and the polymerization solvent from polypropylene particles.

Copolymerization Reactor

The polypropylene particles produced via the polymerization reactors P1, P2, P3 and P4 are introduced into the copolymerization reactor PE, and copolymerization of propylene and ethylene is performed there substantially in a gaseous state, so that a propylene-ethylene block copolymer is formed. A gas phase polymerization reactor such as an agitated gas-phase polymerization reactor and a fluidized bed gas-phase polymerization reactor can be employed as the copolymerization reactor PE. Reactor which can be employed as the polymerization reactors P1, P2, P3 and P4 can be also used as agitated gas-phase polymerization reactor and fluidized bed gas-phase polymerization reactor as the copolymerization reactor.

It is preferred that a specified amount of a catalyst deactivator be added to the copolymerization system in the copolymerization reactor PE. For example, if polypropylene particles that have not yet sufficiently grown are supplied to the copolymerization reactor PE, the copolymerization reaction may advance excessively due to a high activity of the catalyst contained in the polypropylene particles, so that a propylene-ethylene block copolymer containing an excessive amount of propylene-ethylene component may be formed. By controlling the catalytic activity by the action of a catalyst deactivator, it is possible to prevent the copolymerization reaction from advancing excessively and to improve the structural uniformity of the resulting propylene-ethylene block copolymer.

Examples of the catalyst deactivator include compounds that have been generally used for this purpose, such as oxygen-containing electron donors such as oxygen, alcohols, phenols, ketones, aldehydes, carboxylic acids, esters of organic or inorganic acids, ethers, acid amide, and acid anhydrides, and nitrogen-containing electron donors such as ammonia compounds including ammonia and ammonium salts, amines, nitrites, and isocyanates. Among such electron donors, inorganic acid esters and ethers are preferred.

Preferred examples of inorganic acid esters include silicon compounds represented by a formula R¹⁹ₙSi(OR²⁰)₄₋ₙ wherein R¹⁹ represents independently in each occurrence a monovalent hydrocarbon group having 1 to 20 carbon atoms or a hydrogen atom; R²⁰ is independently in each occurrence a monovalent hydrocarbon group having 1 to 20 carbon atoms; n is a number satisfying 0≦n≦4. A silicon compound with n=0 is preferred. Specific examples include tetramethoxysilane, tetraethoxysilane, tetrabutoxysilane, butyltrimethoxysilane, tert-butyl-n-propyldimethoxysilane, dicyclopentyldimethoxysilane, and cyclohexylethyldimethoxysilane.

Preferred ethers are dialkyl ethers and diether compounds represented by a formula:

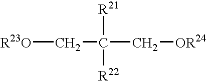

wherein the formula R²¹ to R²⁴ are each independently a linear or branched alkyl group having 1 to 20 carbon atoms, an alicyclic hydrocarbon group, an aryl group, or an aralkyl group; R²¹ or R²² may be a hydrogen atom. Specific examples include dibutyl ether, diamyl ether, 2,2-diisobutyl-1,3-dimethoxypropane and 2,2-dicyclopentyl-1,3-dimethoxypropane.

While the amount of the catalyst deactivator added may be appropriately adjusted according to the type of the solid catalyst and the remaining activity of the catalyst, it is preferred, from the standpoint of carrying out the copolymerization reaction to an appropriate degree, that the catalyst deactivator be added in an amount of 0.005 to 500 mol, more preferably 0.01 to 300 mol per mole of titanium (Ti) contained in the solid catalyst.

The preferred embodiment of the present invention is described above, but the present invention is not limited to the above-described embodiment. While in the foregoing embodiment was provided as one example a case of producing a propylene-based block copolymer by performing propylene homopolymerization by using four polymerization reaction reactors and then performing copolymerization of propylene and ethylene by using one copolymerization reactor, the propylene polymerization may also be performed using a reactor configuration other than the four-reactor configuration, and the copolymerization may be performed using a plurality of reactors. From the standpoint of operation efficiency, it is preferred that the propylene homopolymerization be performed in five or less stages and the copolymerization be performed in three or less stages.

Furthermore, the copolymerization of propylene and ethylene is not limited to gas-phase polymerization and may be also performed by liquid-phase polymerization or bulk polymerization that uses liquid propylene directly as a monomer. However, from the standpoint of the composition and the molecular weight uniformity of the propylene-based block copolymer to be obtained, the elution of the propylene-ethylene component to the liquid phase, and the purified amount of recycled starting materials, it is preferable to use gas-phase polymerization rather that liquid-phase polymerization or bulk polymerization.

### EXAMPLES

The present invention will be explained below by examples and comparative examples thereof. Physical properties were measured and evaluated by the following methods.

(1) Intrinsic Viscosity (Units: dl/g)

The reduced viscosity was measured at three concentrations, 0.1, 0.2, and 0.5 g/dl, in tetralin at 135° C. by using an Ubbelohde viscometer. The intrinsic viscosity was then determined by an extrapolation method by which the reduced viscosity was plotted against the concentration of a solution, and the concentration of a solution was extrapolated to zero in accordance with the method described in “Kobunshi Yoeki, Kobunshi Jikkengaku 11” (published in 1982 by Kyoritsu Shuppan Co., Ltd.), page 491.

(2) Number of Gel (Units: Gel(s)/100 cm²).

A sheet with a thickness of 50 μm was produced from a propylene-based block copolymer and placed on a manuscript platen of a scanner (trade name: GT-9600, resolution 1600 dpi, manufactured by Seiko Epson Corporation). A Hansa Hard Chrome Ferrotype Plate (trade name, manufactured by Omiya Shashin Yohin K.K.) was then placed on the sheet so that the mirror finished surface of the ferrotype plate could face the sheet side.

The scanner resolution was set at 900 dpi, the gradation of each pixel was set at 8 bit, and a monochrome image of the sheet was captured to a computer and was stored in a bitmap format. The image was binarized using an image analysis program (trade name: A ZOKUN, produced by Asahi Kasei Engineering Corporation). Gels were recognized as parts lighter in color than surrounding parts. Because each of the gels had an irregular shape, the diameter of a circle having the same area as that of the image of the gel was taken as the size of the gel. The number of gels was represented by the number of gels found per 100 cm² of the film.

### Example 1

### Preparation of Solid Catalyst

The atmosphere inside a SUS reaction vessel equipped with a stirrer and having an inner capacity of 200 L was replaced with nitrogen. 80 L of hexane, 6.55 mol of tetrabutoxytitanium, 2.8 mol of diisobutyl phthalate, and 98.9 mol of tetraethoxysilane were loaded into the vessel and stirred to give a solution. 51 L of a diisobutyl ether solution of butylmagnesium chloride with a concentration of 2.1 mol/L was added dropwise to the aforementioned solution slowly over 5 hr, while maintaining the temperature inside the reaction vessel at 5° C. Upon the completion of the dropwise addition, stirring was carried out for 1 hr at room temperature, solid-liquid separation was performed at room temperature, and the solid product was washed three times with 70 L of toluene. Toluene was then added so that the slurry concentration would become 0.2 kg/L, and then 47.6 mol of diisobutyl phthalate was added, followed by a reaction for 30 min at 95° C.

Solid-liquid separation was performed after the reaction, and the solid product was washed twice with toluene. Then, 3.13 mol of diisobutyl phthalate, 8.9 mol of dibutyl ether, and 274 mol of titanium tetrachloride were added and a reaction was carried out for 3 hr at 105° C. Upon the completion of the reaction, solid-liquid separation was performed at that temperature, and the solid product was washed twice with 90 L of toluene at the same temperature. The slurry concentration was then adjusted to 0.4 kg/L, and 8.9 mol of dibutyl ether and 137 mol of titanium tetrachloride were added, followed by a reaction for 1 hr at 105° C. Upon the completion of the reaction, solid-liquid separation was performed at that temperature. Then, the solid product was washed six times with 90 L of toluene at 105° C., followed by washing three times with 70 L of hexane. The product was dried under reduced pressure to give 11.4 kg of a solid catalyst component.

(Prepolymerization)

1.5 L of n-hexane which had been fully dehydrated and degassed, 30 mmol of triethylaluminum, and 3.0 mmol of cyclohexylethyldimethoxysilane were placed in a SUS autoclave equipped with a stirrer and having an inner capacity of 3 L. Following the addition of 16 g of the solid catalyst component, 32 g of propylene was continuously supplied over about 40 min while maintaining the temperature in the autoclave at about 3 to 10° C., so that prepolymerization was conducted. The prepolymerized slurry was then transferred to a SUS autoclave equipped with a stirrer and having an inner capacity of 200 L, and 132 L of liquid butane was added thereto to give a slurry of prepolymerized catalyst component.

Using the slurry of the prepolymerized catalyst component prepared in the foregoing manner, four-stage homopolymerization of propylene was conducted in four tandem-connected reactors, giving polypropylene particles. One-stage copolymerization of propylene and ethylene was then performed in the presence of the polypropylene particles, so that propylene-based block copolymer particles were produced. Each polymerization process will be described below.

First-Stage Propylene Polymerization (Liquid-Phase Polymerization)

Homopolymerization of propylene was carried out using a reactor of a vessel type equipped with a stirrer and having an inner capacity of 40 L. Specifically, propylene, hydrogen, triethylaluminum, cyclohexylethyldimethoxysilane, and the slurry of prepolymerized catalyst component were continuously supplied to the reactor. The reaction conditions were as follows: polymerization temperature: 78° C., stirring rate: 150 rpm, liquid level in the reactor: 18 L, supply rate of propylene: 15 kg/hr, supply rate of hydrogen: 100 NL/hr, supply rate of triethylaluminum: 41.3 mmol/hr, supply rate of cyclohexylethyldimethoxysilane: 4.1 mmol/hr, supply rate of the slurry of prepolymerized catalyst component (calculated as a solid catalyst component): 0.43 g/hr, and reactor operation time: 12 hr. The average residence time of the slurry in the reactor was 0.32 hr. The polypropylene particles were discharged at a rate of 2.9 kg/hr.

Second-Stage Propylene Polymerization (Liquid-Phase Polymerization)

The slurry obtained via the first-stage propylene polymerization was continuously transferred to a separate reactor (vessel type), propylene and hydrogen were continuously supplied to this reactor, and homopolymerization of the propylene was further performed. The reaction conditions were as follows: polymerization temperature: 76° C., stirring rate: 150 rpm, liquid level in the reactor: 44 L, supply rate of propylene: 7 kg/hr, supply rate of hydrogen: 30 NL/hr, and reactor operation time: 12 hr. The average residence time of the slurry in the reactor was 0.25 hr and the polypropylene particles were discharged at 7.6 kg/hr.

Third-Stage Propylene Polymerization (Liquid-Phase Polymerization)

The slurry obtained via the second-stage propylene polymerization was continuously transferred to yet another reactor (vessel type), and homopolymerization of the propylene was further performed. The reaction conditions were as follows: polymerization temperature: 68° C., stirring rate: 150 rpm, liquid level in the reactor: 44 L, supply rate of propylene: 5 kg/hr, and reactor operation time: 12 hr. The average residence time of the slurry in the reactor was 1.24 hr, and the polypropylene particles were discharged at 10.7 kg/hr.

Fourth-Stage Propylene Polymerization (Gas-Phase Polymerization)

Polypropylene particles obtained via the third-stage propylene polymerization were continuously transferred to a fluidize bed reactor equipped with a stirrer and having an inner capacity of 1 m³, propylene and hydrogen were continuously supplied to the reactor, and propylene homopolymerization was further performed. The reaction conditions were as follows: polymerization temperature: 80° C., polymerization pressure 1.8 MPa, stirring gas blow rate: 100 m³/hr, gas concentration ratio (vol. %) of gases inside the reactor: propylene/hydrogen=88.8/11.2, amount of polymer particles held in the fluidized bed: 30 kg, and reactor operation time: 20 hr. The average residence time of the polypropylene particles in the reactor was 0.37 hr. The polypropylene particles were discharged at a rate of 14.8 kg/hr and the particles had an intrinsic viscosity of 1.00 dl/g.

Copolymerization (Gas-Phase Polymerization)

Polypropylene particles obtained via the fourth-stage propylene polymerization were continuously transferred to another fluidized-bed reactor equipped with a stirrer and having an inner capacity of 1 m³. Propylene, ethylene, and hydrogen were continuously supplied to the reactor, so that copolymerization of propylene and ethylene was performed. The reaction conditions were as follows: polymerization temperature: 70° C., polymerization pressure: 1.4 MPa, blow rate of circulation gas: 140 m³/hr, concentration ratio (vol. %) of gases inside the reactor: propylene/ethylene/hydrogen=63.8/34.4/1.8, amount of polymer particles held in the fluidized bed: 45 kg, and reactor operation time: 20 hr. Oxygen (deactivator) was added to the supplied gases in an amount corresponding to 0.00031 mol per 1 mol of triethylaluminum supplied to the reactor. The average residence time of polymer particles (propylene-based block copolymer) in the reactor was 0.80 hr. The polymer particles were discharged at a rate of 17.1 kg/hr, and the particles had an intrinsic viscosity of 1.38 dl/g.

### Example 2

A solid catalyst component and a slurry of the prepolymerized catalyst component were prepared by the same methods as those of Example 1. Using the slurry, four-stage homopolymerization of propylene was conducted in four tandem-connected reactors, giving polypropylene particles. Propylene-based block copolymer particles were then produced by one-stage copolymerization of propylene and ethylene in the presence of the polypropylene particles. Each polymerization process will be described below.

First-Stage Propylene Polymerization (Liquid-Phase Polymerization)

Homopolymerization of propylene was carried out using a reactor of a vessel type equipped with a stirrer and having an inner capacity of 40 L. Specifically, propylene, hydrogen, triethylaluminum, cyclohexylethyldimethoxysilane, and the slurry of prepolymerized catalyst component were continuously supplied to the reactor. The reaction conditions were as follows: polymerization temperature: 78° C., stirring rate: 150 rpm, liquid level in the reactor: 18 L, supply rate of propylene: 15 kg/hr, supply rate of hydrogen: 115 NL/hr, supply rate of triethylaluminum: 42.2 mmol/hr, supply rate of cyclohexylethyldimethoxysilane: 4.2 mmol/hr, supply rate of slurry of prepolymerized catalyst component (calculated as solid catalyst component): 0.455 g/hr, and reactor operation time: 12 hr. The average residence time of the slurry in the reactor was 0.27 hr. The polypropylene particles were discharged at a rate of 3.2 kg/hr.

Second-Stage Propylene Polymerization (Liquid-Phase Polymerization)

The slurry obtained via the first-stage propylene polymerization was continuously transferred to a separate reactor (vessel type), propylene and hydrogen were continuously supplied to this reactor, and homopolymerization of the propylene was further performed. The reaction conditions were similar to those of the second-stage propylene polymerization (liquid-phase polymerization reaction) in Example 1, except that the residence time of the slurry was 0.24 hr.

Third-Stage Propylene Polymerization (Liquid-Phase Polymerization Reaction)

The slurry obtained via the second-stage propylene polymerization was continuously transferred to yet another reactor (vessel type), and polymerization was performed in the same manner as that in the third-stage propylene polymerization (liquid-phase polymerization reaction) in Example 1. The average residence time of the slurry in the reactor was 1.37 hr. and the polypropylene particles were discharged at a rate of 10.6 kg/hr.

Fourth-Stage Propylene Polymerization (Gas-Phase Polymerization)

Polypropylene particles obtained via the third-stage propylene polymerization were continuously transferred to a fluidized-bed reactor equipped with a stirrer and having an inner capacity of 1 m³, propylene and hydrogen were continuously supplied to the reactor, and homopolymerization of propylene was further performed. The polymerization was carried out in the same manner as that in the fourth-stage propylene polymerization (gas-phase polymerization reaction) in Example 1, except that the concentration ratio (vol. %) of gases in the reactor was propylene/hydrogen=87.0/13.0 and the amount of polymer particles held in the fluidized bed was 40 kg. The average residence time of polypropylene particles in the reactor was 0.51 hr. The polypropylene particles were discharged at a rate of 14.4 kg/hr, and the particles had an intrinsic viscosity of 0.90 dl/g.

Copolymerization (Gas-Phase Polymerization)

Polypropylene particles obtained via the fourth-stage propylene polymerization were continuously transferred to another fluidized-bed reactor equipped with a stirrer and having an inner capacity of 1 m³. Propylene, ethylene, and hydrogen were continuously supplied to the reactor, so that copolymerization of propylene and ethylene was performed. The polymerization was carried out in the same manner as the first-stage copolymerization (gas-phase polymerization reaction) in Example 1, except that the concentration ratio (vol. %) of gases inside the reactor was propylene/ethylene/hydrogen=72.6/26.9/0.5, and oxygen (deactivator) was added to the supplied gases in an amount corresponding to 0.0003 mol per 1 mol of triethylaluminum supplied to the reactor. The average residence time of polymer particles (propylene-based block copolymer) in the reactor was 1.02 hr. The polymer particles were discharged at 16.3 kg/hr, and the intrinsic viscosity thereof was 1.42 dl/g.

### Example 3

A solid catalyst component and a slurry of the prepolymerized catalyst were prepared by the methods same methods as those of Example 1. Using the slurry, four-stage homopolymerization of propylene was conducted in four tandem-connected reactors, giving polypropylene particles. A powdered propylene-based block copolymer was then produced by one-stage copolymerization of propylene and ethylene in the presence of the polypropylene particles. Each polymerization process will be described below.

First-Stage Propylene Polymerization (Liquid-Phase Polymerization)

Homopolymerization of propylene was carried out using a reactor of a vessel type equipped with a stirrer and having an inner capacity of 40 L. Specifically, propylene, hydrogen, triethylaluminum, cyclohexylethyldimethoxysilane, and the slurry of prepolymerized catalyst component were continuously supplied to the reactor. The reaction conditions were as follows: polymerization temperature: 78° C., stirring rate: 150 rpm, liquid level in the reactor: 18 L, supply rate of propylene: 18 kg/hr, supply rate of hydrogen: 155 NL/hr, supply rate of triethylaluminum: 41.8 mmol/hr, supply rate of cyclohexylethyldimethoxysilane: 6.2 mmol/hr, supply rate of slurry of prepolymerized catalyst component (calculated as solid catalyst component): 0.445 g/hr, and reactor operation time: 12 hr. The average residence time of the slurry in the reactor was 0.33 hr and the polypropylene particles were discharged at a rate of 2.7 kg/hr.

Second-Stage Propylene Polymerization (Liquid-Phase Polymerization)

The slurry obtained via the first-stage propylene polymerization was continuously transferred to a separate reactor (vessel type), propylene and hydrogen were continuously supplied to this reactor, and homopolymerization of the propylene was further performed. Polymerization was carried out in the same manner as the second-stage propylene polymerization (liquid-phase polymerization) in Example 1, except that the supply rate of hydrogen was 50 Nl/hr. The average residence time of the slurry in the reactor was 0.26 hr, and the polypropylene particles were discharged at a rate of 9.5 kg/hr.

Third-Stage Propylene Polymerization (Liquid-Phase Polymerization)

The slurry obtained via the second-stage propylene polymerization was continuously transferred to yet another reactor (vessel type) and homopolymerization of propylene was further performed. Polymerization was carried out in the same manner as the third-stage propylene polymerization (liquid-phase polymerization reaction) in Example 1, except that the liquid level in the reactor was 80 L. The average residence time of the slurry in the reactor was 1.05 hr, and the polypropylene particles were discharged at a rate of 13.6 kg/hr.

Fourth-Stage Propylene Polymerization (Gas-Phase Polymerization)

Polypropylene particles obtained via the third-stage propylene polymerization were continuously transferred to a fluidized-bed reactor equipped with a stirrer and having an inner capacity of 1 m³, propylene and hydrogen were continuously supplied to the reactor, and homopolymerization of propylene was further performed. The polymerization was carried out in the same manner as that in the fourth-stage propylene polymerization (gas-phase polymerization reaction) in Example 1, except that the concentration ratio (vol. %) of gases inside the reactor was propylene/hydrogen=85.0/15.0 and the amount of polymer particles held in the fluidized bed was 50 kg. The average residence time of polypropylene particles in the reactor was 0.51 hr. The polypropylene particles were discharged at a rate of 16.4 kg/hr, and the particles had an intrinsic viscosity of 0.80 dl/g.

Copolymerization (Gas-Phase Polymerization)

Polypropylene particles obtained via the fourth-stage propylene polymerization were continuously transferred to another fluidized-bed reactor equipped with a stirrer and having an inner capacity of 1 m³. Propylene, ethylene, and hydrogen were continuously supplied to the reactor, so that copolymerization of propylene and ethylene was performed. The polymerization was carried out in the same manner as that in the first-stage copolymerization (gas-phase polymerization reaction) in Example 1, except that the concentration ratio (vol. %) of gases inside the reactor was propylene/ethylene/hydrogen=69.9/29.9/0.2, the amount of polymer particles held in the fluidized bed was 40 kg, and oxygen (deactivator) was added to the supplied gases in an amount corresponding to 0.0003 mol per 1 mol of triethylaluminum supplied to the reactor. The average residence time of polymer particles (propylene-based block copolymer) in the reactor was 1.21 hr. The polymer particles were discharged at a rate of 18.3 kg/hr, and the particles had an intrinsic viscosity of 1.41 dl/g.

### Example 4

A cylindrical reactor (inner capacity 200 L, diameter 0.5 m) equipped with a stirring apparatus having three pairs of stirring blades (diameter 0.35 m) and four hindrance plates (width 0.05 m) was prepared, and the atmosphere inside the reactor was replaced with nitrogen. 54 L of hexane, 100 g of diisobutyl phthalate, 20.6 kg of tetraethoxysilane, and 2.23 kg of tetrabutoxytitanium were loaded into the reactor and stirred to give a solution. 51 L of a dibutyl ether solution of butylmagnesium chloride with a concentration of 2.1 mol/L was added dropwise to the aforementioned solution slowly over 4 hr, while maintaining the temperature inside the reaction vessel at 7° C. The stirring rate was 150 rpm. Upon the completion of the dropwise addition, stirring was carried out for 1 hr at 20° C., followed by filtration. The resulting solid product was washed three times with 70 L of toluene at room temperature. Toluene was then added to give a solid catalyst component precursor slurry. The solid catalyst component precursor contained 1.9 wt. % Ti, 35.6 wt. % OEt (ethoxy group), and 3.5 wt. % OBu (butoxy group). The average particle size of the precursor was 39 μm, and the amount of fine component with a size of equal to or less than 16 μm was 0.5 wt. %.

Toluene was then extracted so that the slurry volume would become 49.7 L, and stirring was then conducted for 1 hr at 80° C. The slurry was then cooled to a temperature equal to or lower than 40° C. A mixed liquid containing 30 L of tetrachlorotitanium and 1.16 kg of dibutyl ether was charged therein under stirring and 4.23 kg of orthophthalic acid chloride was also charged into the slurry. Stirring was conducted for 3 hr at a temperature inside the reactor of 110° C., followed by filtration. The resulting solid product was washed three times with 90 L of toluene at 95° C., and then toluene was added to give a slurry. The slurry was allowed to settle, toluene was then extracted so that the slurry volume would become 49.7 L, and a mixed liquid containing 15 L of tetrachlorotitanium, 1.16 kg of dibutyl ether, and 0.87 kg of diisobutyl phthalate was charged. Stirring was then conducted for 1 hr at a temperature inside the reactor of 105° C., followed by filtration. The resulting solid product was washed twice with 90 L of toluene at 95° C.

The slurry prepared by the addition of toluene was then allowed to settle again, and toluene was extracted so that the slurry volume would become 49.7 L. A mixed liquid of 15 L of tetrachlorotitanium and 1.16 kg of dibutyl ether was charged under stirring. Stirring was conducted for 1 hr at a temperature inside the reactor of 105° C., followed by filtration. The resulting solid product was washed twice with 90 L of toluene at 95° C., and then toluene was added to give a slurry. After the slurry was allowed to settle, toluene was extracted so that the slurry volume would become 49.7 L, and a mixed liquid containing 15 L of tetrachlorotitanium and 1.16 kg of dibutyl ether was charged under stirring. Stirring was performed for 1 hr at a temperature inside the reactor of 105° C., followed by filtration. The solid product obtained was washed three times with 90 L of toluene at 95° C. and washed twice with 90 L of hexane. The solid component obtained was dried, giving a solid catalyst component. The solid catalyst component contained Ti at 2.1 wt. % and a phthalate component at 10.8 wt. %.

Two-stage propylene homopolymerization was performed in two tandem-connected reactors by using the solid catalyst component prepared in the above-described manner, so that polypropylene particles were produced. One-stage copolymerization of propylene and ethylene was then performed in the presence of the polypropylene particles, so that a powdered propylene-based block copolymer was produced. Each polymerization process will be described below.

First-Stage Propylene Polymerization (Liquid-Phase Polymerization)

The atmosphere inside a SUS loop-type liquid-phase polymerization reactor with an inner capacity of 0.36 m³ was sufficiently replaced with propylene. Then, triethylaluminum at 0.063 mol/hr and t-butyl-n-propyl-dimethoxysilane at 0.017 mol/hr were supplied. The temperature inside the reactor was adjusted to 45 to 55° C., and the pressure was adjusted to 3.2 to 3.4 MPaG with propylene and hydrogen. The polymerization propylene was started by starting the feed of the solid catalyst component, and then the solid catalyst component was continuously supplied for 8 hr at a rate of 0.020 to 0.030 kg/hr. The polymer produced in the loop-type liquid-phase polymerization reactor was extracted to a gas-phase polymerization reactor.

Second-Stage Propylene Polymerization (Gas-Phase Polymerization)

The gas-phase polymerization reactor included two reactors. The propylene concentration in the first reactor (inner capacity 45.75 m³) was reduced as much as possible, while circulating nitrogen under low-temperature and low-pressure conditions (temperature 65° C., pressure 0.5 MPaG), and a polymer produced in the loop-shaped liquid-phase polymerization reactor was introduced therein. The reaction was thus prevented from advancing when the polymer produced in the loop-type liquid-phase polymerization reactor was extracted to the gas-phase polymerization reactor.

The solid catalyst component was continuously supplied for 8 hr, the supply was then completed, and at the point in time the polymer produced in the loop-type liquid-phase polymerization reactor was entirely extracted to the first reactor, the circulation of nitrogen in the first reactor was stopped. Propylene at 200 to 300 kg/hr and hydrogen at 25 to 30 Nm³/hr were then continuously supplied to the first reactor, and the reaction was restarted, while raising the pressure. The amount of charged propylene was adjusted so as to maintain the pressure inside the first reactor at 1.5 to 2.0 MPa, and the amount of charged hydrogen was adjusted so as to maintain the concentration of hydrogen in the gas-phase unit at 14 to 16 vol. %. A propylene homopolymer component (referred to hereinbelow as “polymer component (I)”) was produced under such conditions. Once the amount of the polymer component (I) contained in the reactor reached 2.4 ton, the polymer was extracted into the second container (inner capacity 40.59 m³). The conditions inside the second reactor were adjusted so as to be identical to the conditions in the first reactor before the polymer was introduced therein. Polymerization of the polymer component (I) was then further carried out in the second reactor. Because the concentration of hydrogen in the second reactor had to be greatly reduced, nitrogen circulation was continued for 2 hr even after the polymer was introduced therein.

Copolymerization (Gas-Phase Polymerization)

The polymer component (I) polymerized in the second reactor was continuously introduced into the third reactor (copolymerization reactor, inner capacity 40.59 m³). Propylene was continuously supplied into the third reactor so as to maintain the reaction pressure at 1.1 to 1.5 MPa at a reaction temperature of 65° C., and gas-phase polymerization of an ethylene-propylene copolymer component (referred to hereinbelow as “polymer component (II)”) was carried out, while performing the supply so as to obtain an ethylene concentration in the gas-phase unit of 0.01 to 0.05 vol. % and an ethylene concentration in the gas-phase unit of 21 to 23 vol. %. Once the amount of the polymer reached 3.9 ton, the reaction was ended. A powder containing the polymer component (I) and polymer component (II) was then continuously introduced from the third reactor into a deactivation reactor and a deactivation treatment of the catalyst component was carried out with water. The powder was then dried with nitrogen at 80° C., so that a white powder composed of a propylene-(ethylene-propylene) block copolymer was obtained.

### Comparative Example 1

A solid catalyst component and a slurry of prepolymerized catalyst component were prepared by the same method as that used in Example 1. Two-stage propylene homopolymerization was performed in two tandem-connected reactors by using the slurry, so that polypropylene particles were produced. One-stage copolymerization of propylene and ethylene was then performed in the presence of the polypropylene particles, so that a propylene-ethylene block copolymer was produced. Each polymerization process will be described below.

First-Stage Propylene Polymerization (Liquid-Phase Polymerization)

Homopolymerization of propylene was carried out using a reactor of a vessel type equipped with a stirrer and having an inner capacity of 200 L. Specifically, propylene, hydrogen, triethylaluminum, cyclohexylethyldimethoxysilane, and the slurry of prepolymerized catalyst component were continuously supplied to the reactor. The reaction conditions were as follows: polymerization temperature: 78° C., stirring rate: 150 rpm, liquid level in the reactor: 44 L, supply rate of propylene: 35 kg/hr, supply rate of hydrogen: 166 NL/hr, supply rate of triethylaluminum: 41.8 mmol/hr, supply rate of cyclohexylethyldimethoxysilane: 6.2 mmol/hr, supply rate of slurry of prepolymerized catalyst component (calculated as solid catalyst component): 0.595 g/hr, and reactor operation time: 12 hr. The average residence time of the slurry in the reactor was 0.63 hr, and the polypropylene particles were discharged at a rate of 6.0 kg/hr.

Second-Stage Propylene Polymerization (Liquid-Phase Polymerization)

The polypropylene particles obtained via the first-stage propylene polymerization were continuously transferred to a fluidized-bed reactor equipped with a stirrer and having an inner capacity of 1 m³. Propylene and hydrogen were continuously supplied to this reactor, so that homopolymerization of the propylene was further performed. The reaction conditions were as follows: polymerization temperature: 80° C., polymerization pressure 1.8 MPa, blow rate of circulation gas 100 m³/hr, concentration ratio (vol. %) of gases inside the reactor: propylene/hydrogen=90.0/10.0, amount of polymer particles held in the fluidized bed; 55 kg, and reactor operation time: 20 hr. The average residence time of the polypropylene particles in the reactor was 4.01 hr. The polypropylene particles were discharged at a rate of 13.8 kg/hr, and the particles had an intrinsic viscosity of 1.00 dl/g.

First-Stage Copolymerization (Gas-Phase Polymerization)

Polypropylene particles obtained from the second-stage propylene polymerization were continuously transferred to a fluidized-bed reactor equipped with a stirrer and having an inner capacity of 1 m³. Propylene, ethylene, and hydrogen were continuously supplied to the reactor, so that copolymerization of propylene and ethylene was performed. The reaction conditions were as follows: polymerization temperature: 70° C., polymerization pressure: 1.4 MPa, blow rate of circulation gas: 140 m³/hr, concentration ratio (vol. %) of gases inside the reactor: propylene/ethylene/hydrogen=69.9/28.5/1.6, amount of polymer particles held in the fluidized bed: 45 kg, and reactor operation time: 20 hr. Oxygen (deactivator) was added to the supplied gases in an amount corresponding to 0.0003 mol per 1 mol of triethylaluminum supplied to the reactor. The average residence time of polymer particles (propylene-based block copolymer) in the reactor was 2.66 hr. The polymer particles were discharged at a rate of 16.9 kg/hr, and the particles had an intrinsic viscosity of 1.49 dl/g.

### Comparative Example 2

A solid catalyst component and a slurry of prepolymerized catalyst component were prepared by the same method as that used in Example 1. One-stage propylene homopolymerization was performed using the slurry, so that polypropylene particles were produced. One-stage copolymerization of propylene and ethylene was then performed in the presence of the polypropylene particles, so that a powdered propylene-based block copolymer was produced. Each polymerization process will be described below.

First-Stage Propylene Polymerization (Gas-Phase Polymerization)

Homopolymerization of propylene was carried out using a fluidized-bed reactor equipped with a stirrer and having an inner capacity of 1 m³. Specifically, propylene, hydrogen, triethylaluminum, cyclohexylethyldimethoxysilane, and the slurry of prepolymerized catalyst component were continuously supplied to the reactor. The reaction conditions were as follows: polymerization temperature: 80° C., polymerization pressure: 1.8 MPa, blow rate of circulation gas: 100 m³/hr, concentration ratio (vol. %) of gases inside the reactor: propylene/hydrogen=90.0/10.0, supply rate of triethylaluminum: 41.0 mmol/hr, supply rate of cyclohexylethyldimethoxysilane: 6.1 mmol/hr, amount of polymer particles held in the fluidized bed: 70 kg, supply rate of slurry of prepolymerized catalyst component (calculated as solid catalyst component): 0.90 g/hr, and reactor operation time: 20 hr. The average residence time of polymer particles (propylene-based block copolymer) in the reactor was 4.63 hr. The polypropylene particles were discharged at a rate of 15.1 kg/hr, and the particles had an intrinsic viscosity of 1.00 dl/g.

Copolymerization (Gas-Phase Polymerization)

Polypropylene particles obtained via the first-stage propylene polymerization were continuously transferred to a fluidized-bed reactor equipped with a stirrer and having an inner capacity of 1 m³. Propylene, ethylene, and hydrogen were continuously supplied to the reactor, and copolymerization of propylene and ethylene was performed. The reaction conditions were as follows: polymerization temperature: 70° C., polymerization pressure: 1.4 MPa, blow rate of circulation gas: 140 m³/hr, concentration ratio (vol. %) of gases inside the reactor: propylene/ethylene/hydrogen=64.7/33.3/2.0, amount of polymer particles held in the fluidized bed: 65 kg, and reactor operation time: 20 hr. Oxygen (deactivator) was added to the supplied gases in an amount corresponding to 0.004 mol per 1 mol of triethylaluminum supplied to the reactor. The average residence time of polymer particles (propylene-based block copolymer) in the reactor was 3.18 hr. The polymer particles were discharged at a rate of 20.4 kg/hr, and the particles had an intrinsic viscosity of 1.72 dl/g.

The average residence time in polymerization reactors and the results obtained in measuring mechanical properties and evaluating propylene-based block copolymer particles in Examples 1 to 4 and Comparative Examples 1 and 2 are shown in Table 1.

TABLE 1

| | | | | | | Comp. | Comp. |
|---|---|---|---|---|---|---|---|
| | | Ex. 1 | Ex. 2 | Ex. 3 | Ex. 4 | Ex. 1 | Ex. 2 |
| Average residence time | First stage | 0.32 | 0.27 | 0.33 | 0.30 | 0.63 | 4.63 |
| of particles in propylene | Second stage | 0.25 | 0.24 | 0.26 | 2.00 | 4.01 | — |
| polymerization reactor (hr) | Third stage | 1.24 | 1.37 | 1.05 | — | — | — |
| | Fourth stage | 0.37 | 0.51 | 0.51 | — | — | — |

| | | | | | | |
|---|---|---|---|---|---|---|
| Average residence time of particles | 0.80 | 1.02 | 1.21 | 2.00 | 2.66 | 3.18 |
| in copolymerization reactor (hr) | | | | | | |
| Content of EP part in particles (wt. %) | 11.7 | 10.5 | 8.5 | 33.5 | 16.9 | 24.8 |
| Standard deviation of ethylene content | 4.6 | 4.0 | 2.8 | 2.3 | 7.7 | 7.6 |
| Ethylene content (wt. %) in EP part | 49.7 | 41.3 | 44.6 | 26.0 | 43.2 | 48.1 |
| Intrinsic viscosity (η_{A}) of | 3.59 | 5.00 | 6.62 | 5.22 | 3.43 | 3.56 |
| xylene-soluble component (dl/g) | | | | | | |
| Intrinsic viscosity (η_{B}) of | 1.17 | 1.04 | 0.93 | 1.55 | 1.28 | 1.40 |
| xylene-insoluble component (dl/g) | | | | | | |
| Ratio of intrinsic viscosities (η_{A}/η_{B}) | 3.1 | 4.8 | 7.1 | 3.4 | 2.7 | 2.5 |
| Isotactic pentad fraction of PP part | 0.985 | 0.986 | 0.988 | 0.982 | 0.985 | 0.983 |
| Number of gel(s) with a diameter of equal to or | 1160 | 990 | 700 | 250 | 4410 | 14300 |
| greater than 100 μm (gel(s)/100 cm²) | | | | | | |

What is claimed is:

1. Propylene-based block copolymer particles obtained by copolymerizing ethylene and propylene to form an ethylene-propylene copolymer in the presence of propylene polymer particles,
wherein the ratio of the intrinsic viscosity η_{A} of a 20° C. xylene-soluble component in the block copolymer particles to the intrinsic viscosity η_{B} of a 20° C. xylene-insoluble component in the block copolymer particles, η_{A}/η_{B}, is 2.9 to 7.5;
the content of the ethylene-propylene copolymer is 5 to 50 wt. % on the basis of the total weight of the block copolymer particles;
the ethylene content of the ethylene-propylene copolymer is 20 to 55 wt. % on the basis of the weight of the ethylene-propylene copolymer; and
the standard deviation of the ethylene contents of the individual block copolymer particles is less than 7.

2. The propylene-based block copolymer particles according to claim 1, wherein the intrinsic viscosity η_{A} of the 20° C. xylene-soluble component is 3.0 to 7.0 dl/g.

3. The propylene-based block copolymer particles according to claim 1, wherein the propylene polymer has an isotactic pentad fraction of 0.98 or more.

4. The propylene-based block copolymer particles according to claim 2, wherein the propylene polymer has an isotactic pentad fraction of 0.98 or more.
